(19) United States
(12) Patent Application Publication
(10) Pub. No.: US 2012/0227326 A1
(43) Pub. Date: Sep. 13, 2012

(54) Covering For A Door Operator

(76) Inventors: Matthias Drux, Gevelsberg (DE); Dietmar Finis, Remscheid (DE)

(21) Appl. No.: 13/509,239

(22) PCT Filed: Nov. 13, 2009
(86) PCT No.: PCT/EP2009/008085

§ 371 Date: May 10, 2012

(51) Int. Cl. E05F 11/54

(52) U.S. Cl. 49/358; 49/506

(57) ABSTRACT

A door operator adapted to open and/or to close a connected door leaf and to be stationarily affixed to a carrying body. The door operator has at least one lateral screen and a covering hood, which, in the installed condition is open at one of the at least one lateral screen. Fastening devices are configured to stationarily receive at least one of the at least one lateral screen at an associated frontal side of the door drive. In addition, the door operator has fastening devices, which are configured to stationarily receive the covering hood.

### CROSS REFERENCE TO RELATED APPLICATION

This is a U.S. national stage of application No. PCT/EP2009/008085, filed on 13 Nov. 2009.

### BACKGROUND OF THE INVENTION

1. Field of the Invention

The invention relates to an encasing for a door drive adapted to open and/or to close a connected door leaf.

2. Description of Prior Art

Door operators, namely door drives or door closers, are provided for actuating a door leaf of a door system. With pivotable doors, such door operators are installed most of the time at a top side at a door transom or a wall and are operatively connected to an associated door leaf via an arm assembly. There are door operators configured with an electro-motor or with electro-hydraulics. Such door drives for opening the door are typically activated by a momentary contact switch or a motion-sensor, and they execute both the opening procedure of the door leaf and the mostly time-delayed closing procedure. Furthermore, door operators are known which, for the purpose of controlling an escape route for example, are coupled to a bus of a building. Fully automatic door operators are very common in particular in public buildings, as well as in the infrastructure area of larger building complexes, which have a higher volume of people passing through.

For the installation, the door operator has a mounting plate, stationarily affixed to a carrying body, namely a door transom, a wall, a casing, a door leaf or a door frame for example, by a screw-connection or any other known type of connection. Once the mounting plate is installed at the carrying body, the door operator itself is installed on the mounting plate. For mounting the door operator, the plate has, for example, pre-fabricated threaded bores or through-openings for screw-connections to firmly connect the door operator to said carrying body via the mounting plate.

From the state-of-the-art encasings are known, that are realized by covering hoods which are simply open towards the mounting plate of such a door operator. This means, they encase the door drive towards all visible sides, respectively they cover the door drive to these sides. Such covering hoods are disadvantageous in that, for each type of door operator with a different length, different covering hoods need to be manufactured. In addition, appropriate devices are to be provided in the covering hoods such that control elements or display elements, such as switches or the like are accessible from outside.

### SUMMARY OF THE INVENTION

It is an object of the present invention to eliminate the above mentioned disadvantages.

An inventive door operator is adapted to open and to close a connected door leaf. It is furthermore adapted to be stationarily affixed to a carrying body, such as a casing, a transom, a door leaf, or the like. The door operator has at least one lateral screen and a covering hood. In the installed condition, the covering hood is configured to be open towards the respective lateral screen. This means the at least one lateral screen, and not the covering hood, forms the frontal termination of the so-formed encasing for the door operator. According to the invention, the door operator has fastening devices, which are configured to stationarily receive the respective lateral screen at a respective frontal side of the door operator. In addition the door operator has fastening devices, which are configured to stationarily receive the covering hood. On the one hand, it is thereby possible to have the door operator exclusively retain the parts of the encasing, namely the lateral screen(s) and the covering hood, which makes installation easy in so far as the parts only need to be placed onto the door operator. Furthermore, it is still possible to completely cover the door operator towards the respective frontal side by means of associated lateral screen(s) and to the other sides by means of the covering hood, like a traditional covering hood would achieve on its own.

Preferably the door drive has appropriate fastening devices and lateral screens for each frontal side. This feature allows for manufacturing covering hoods which are open towards both frontal sides. This feature also allows for manufacturing endless extruded parts having for example a C-shaped or U-shaped cross-section that matches the desired cross-sectional shape of the covering hood. The manufactured profile is then cut to length at the desired locations, which results in very simple and inexpensive manufacturing. In particular no control elements need to be affixed to the newly created covering hoods, if it is not desired. Therefore, in order to access said control elements and/or display elements, it is furthermore advantageous that it is no longer required to remove the covering hood including the above elements with the risk of tearing off the electrical lines or the like. With the covering hood being removed, the lateral screen(s) and thus the control elements and/or the display elements remain preferably installed.

Furthermore, the door operator has preferably, at least at one frontal side, a fastening device configured to stationarily receive an associated electronic component at a respective frontal side of the door drive. Such components may include switches, display elements or the like, which are advantageously disposed on a printed circuit board. Uninstalling/installing the associated lateral screen is thus possible without having to remove the electronic component, in addition to the advantage of lowering the risk of damaging for example electrical lines, as already described in conjunction with the covering hood.

In a preferred embodiment, each lateral screen advantageously comprises devices such as through-bores and the like, which allow for accessing or seeing the control and/or display elements, such as switches, LEDs, displays etc, from the outside with regard to the door drive. Therefore, it is no longer required to manipulate the covering hood, and it no longer needs to have such drive specific devices.

As an alternative or in addition, at least one lateral screen has at least one through-bore, which, in the installed condition, extends along a longitudinal extension of the door drive and is aligned with a cooling air stream of the door drive in the area of this lateral screen. An air stream for cooling the door operator, respectively parts thereof, such as the power supply unit, electronic components, the control and the like, can thus be realized. This means neither in this case nor the covering hood needs to be machined.

A mounting method for such a door drive includes a step of placing onto, respectively inserting at least one lateral screen into the associated fastening devices of the door drive and a step of placing the covering hood onto the door drive provided with the one or more lateral screens.

If the door operator has in addition, as mentioned above, at least one electronic component to be frontally mounted, according to the invention, the mounting method furthermore includes a step of fastening this electronic component to the associated frontal side of the door operator. This step is executed prior to installing the lateral screen to be installed at the same frontal side of the door operator.

### BRIEF DESCRIPTION OF THE DRAWINGS

Hereinafter, further measures enhancing the invention will be illustrated in detail in conjunction with the description of one preferred embodiment of the invention based on the Figures, in which:

FIG. 1 is a door drive according to an embodiment of the invention;

FIG. 2 is the door drive of FIG. 1 without covering hood and with a lateral screen modified compared to FIG. 1;

FIGS. 3a-3c are partial views of the door drive of FIG. 1 with regard to affixing the switch part of FIG. 1;

FIGS. 4a-4c are partial views of FIG. 1 with regard to affixing the lateral screen of FIG. 1;

FIGS. 5a-5c are partial views of the door drive of FIG. 1, with regard to affixing a lateral screen to the frontal side of the door drive which is concealed in FIG. 1;

FIG. 6 is the door drive of FIG. 1 in an exploded view;

FIG. 7 is a method for mounting the encasing for the door drive of FIG. 1 according to a first embodiment of the invention; and

FIG. 8 is a method for mounting the covering for the door drive of FIG. 1 according to a second embodiment of the invention.

### DETAILED DESCRIPTION OF THE PREFERRED EMBODIMENTS

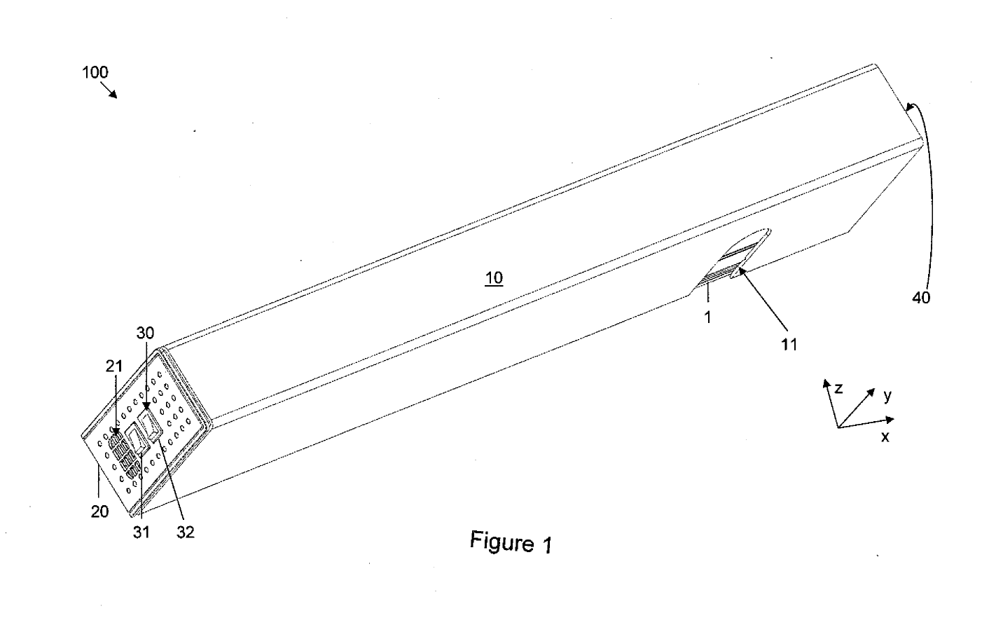

FIG. 1 shows parts of a door drive 100 according to an embodiment of the invention. This embodiment is configured for a door leaf which is independently actuated by a door drive 100. For the sake of clarity, the driving components of the door drive 100 are not illustrated.

The door drive 100 has a mounting plate 1, which, in a known way, is affixed to a likewise not illustrated carrying body, such as a door casing, a door transom, a door leaf, or the like.

A covering hood 10 is “put over” the mounting plate 1 so the latter is concealed to the outside. In FIG. 1 at least at the side pointing downwards, namely in −z coordinate direction, preferably however also at the opposite non-visible side, namely pointing into the +z coordinate direction, the covering hood 10 has a respective recess, or opening 11, which serves to expose the respective end of an output shaft of the door drive 100 so it can be coupled in a known manner to a driving linkage system.

In FIG. 1, a lateral screen 20, by way of example in the shape of a perforated screen, is disposed at the left side, which screen frontally terminates the entire covering, respectively the covering hood 10 and therefore frontally encases, respectively covers the door drive 100. This means the lateral screen 20 has the function of a terminal cap and, in the illustrated example, allows for disposing a switch member 30, by way of example having two switches 31, 32. In this case, to the left of the switches 31, 32, again by way of example, the lateral screen 20 has matrix-like disposed through-openings that form a ventilating grille 21.

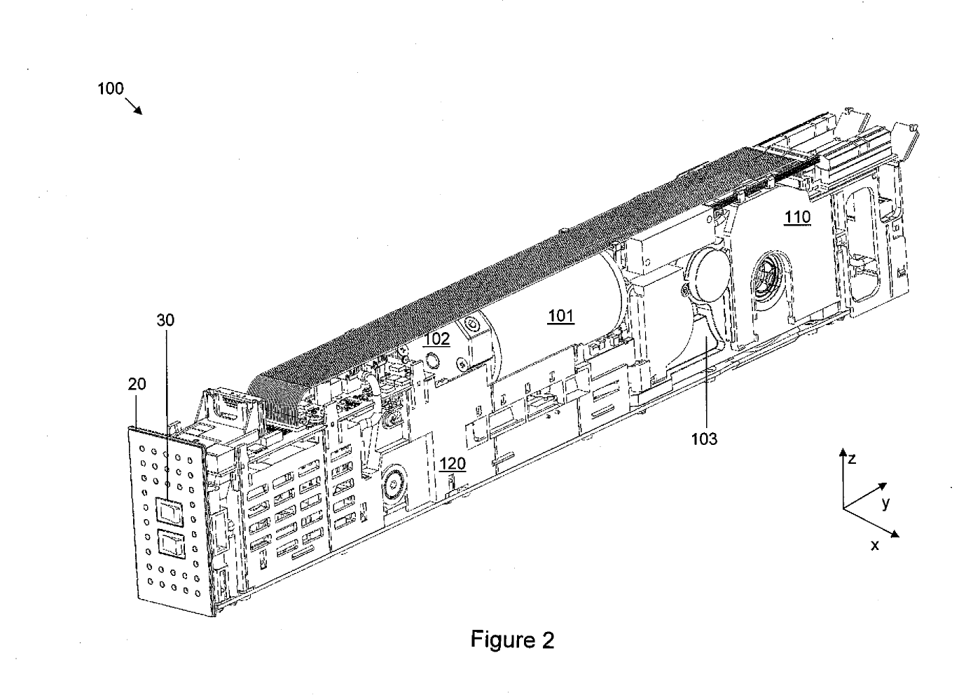

The ventilating grille 21 serves the purpose of letting air flow into the inside between the covering hood 10 and the mounting plate 1 or of evacuating warm air from the inside covering hood 10 to the outside. Warm air develops when operating such electric door drives 100, i.e. motor-driven door drives. Heat development may occur in the door drive 100, when a motor 101 of the door drive 100, illustrated in FIG. 2, is under load while opening, respectively closing the connected door leaf, respectively when the electrical components, such as the power supply units and the like, for supplying power and controlling, are under load. If the heat is not evacuated, the door drive 100 could overheat and be damaged. The same may obviously apply to potential other components such as a light curtain, radar alarm, or the like, which may be likewise covered by the covering hood 10. In order to prevent damage, the heat needs to be evacuated, by either convection or by active ventilators. In order to guarantee ventilation, cold air needs to be supplied to at least one location from the outside to said inside and, at least at one other location, it needs to be evacuated from said inside to the outside.

If a frontal side or the lateral screen 20 thereof is disposed to have a minimum distance to a neighbouring wall, so the air can flow unhindered into one frontal side of the arrangement 20 and flow out of the other frontal side, the solution embodied by the aforementioned ventilation grille 21 is suggested. A lateral screen 40, which will be explained later in detail, is disposed at the right concealed end in FIG. 1, which, with respect to the air flow, is configured similarly to the lateral screen 20. Thereby air flow is realized.

FIG. 2 shows the door drive 100 of FIG. 1 without the covering hood 10, but with a lateral screen 20, which is modified compared to FIG. 1. In this case the ventilating grille 21 is omitted. As driving components, the door drive 100 has the above mentioned motor 101, the non-visible driving shaft thereof, to the right side in FIG. 2, being operatively coupled to a gear, which is received in a housing 103. In FIG. 2, in the right terminal area of the gear housing 103, a connecting module 110 is attached to the latter.

The connecting module 110 mainly serves to electrically couple the door drive 100 to an external power supply and has appropriate electrical connections not illustrated in detail.

By way of example, the motor 101 has a drive shaft exiting at both sides. The end exiting on the left side is operatively coupled to a blocking device 102, which may be a part of a non-illustrated closing sequence control.

A system carrier 120 of the door drive 100 is located adjacent to the left side of the gear housing 103. Preferably the system carrier 120 is adapted to stationarily receive or to retain additional driving components such as a power supply unit, a driving control, sensors, and the like.

The lateral screen 20 and the switch member 30, as will be explained below, are preferably affixed to the left frontal side of the system carrier 30, namely at the side facing away from the gear housing 103.

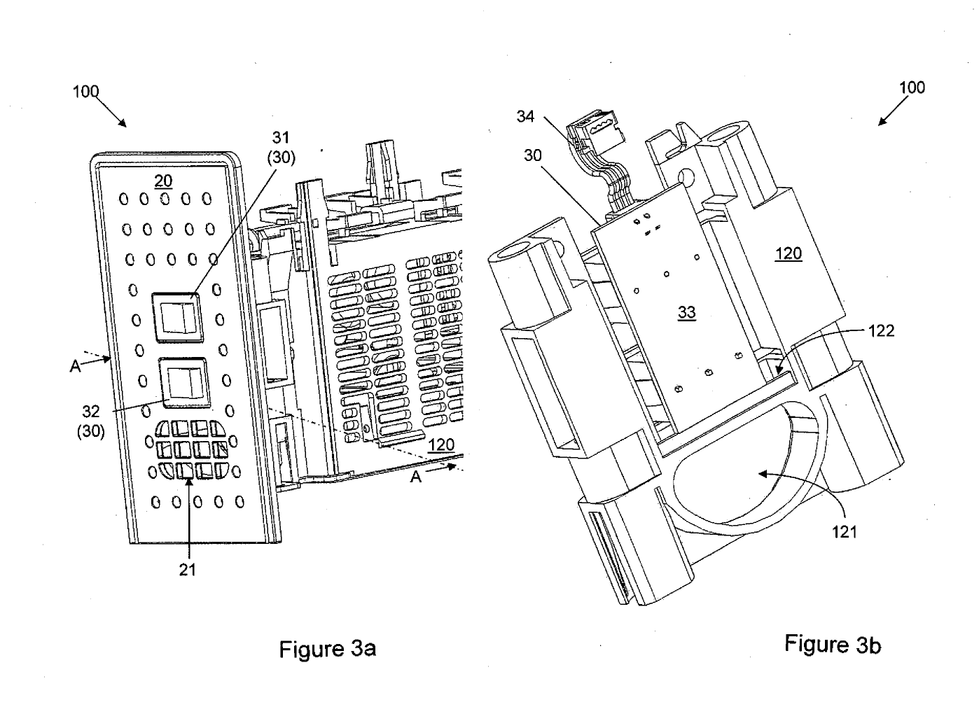

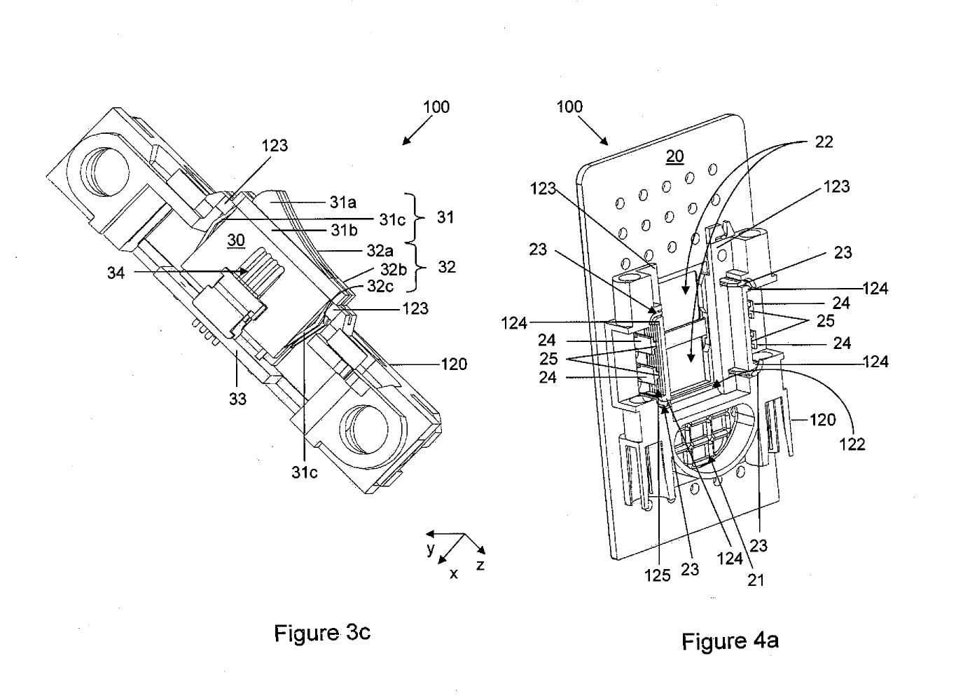

FIG. 3 shows partial views of the door drive 100 of FIG. 1, with regard to affixing the switch member 30 of FIG. 1, respectively in an enlarged cut out. In this case, FIG. 3a shows the door drive 100 in an arrangement of FIG. 1 without the covering hood 10 and mounting plate 1. FIG. 3b shows this arrangement in a section along a line A-A of FIG. 3a in an essentially rear perspective, which differs from FIG. 3a.

As shown in FIG. 3a, by way of example at its left frontal side, the door drive 100 is equipped with an electronic component configured as a switch member 30. Furthermore, the lateral screen 20 is disposed at this frontal side, in the shape of a perforated screen. The lateral screen 20 terminates the frontal side of the door drive 100. This means the lateral screen 20 has the function of a terminal cap and, in the illustrated example, allows for disposing the switch member 30, which by way of example, has two switches 31, 32. Below the switches 31, 32, the lateral screen 20 has through-openings disposed in a matrix and form the aforementioned ventilating grille 21.

As indicated above, the ventilating grille 21 provides air flow into the inside chamber, between the non-illustrated covering hood 10 and through the driving components 101 to 103, in this case indicated by way of example, or to evacuate warm air from this inside chamber to the outside. With regard to the system carrier 120 and the connecting module 110, the air may likewise flow through these parts of the door drive 100 to cool additional components such as the power supply unit, the control, and the like.

By way of example, the switch member 30 comprises a printed circuit board 33 on which the switches 31, 32 are disposed. Furthermore, a connecting cable 34 starts at the printed circuit board 34 and leads to a non-illustrated control device. During installation, the switch member 30 is inserted into the system carrier 120 from the top in FIG. 3, preferably without any additional fastening elements. Thereafter, the lateral screen 20 is placed onto the system carrier 120 at the frontal side thereof.

By way of example, the system carrier 120 comprises a support surface 122. The support surface 122 thus forms a support for the switch member 30, respectively the printed circuit board 33 thereof.

Preferably the switches 31, 32 of the switch member 30 offer support in the system carrier 120. As shown in FIG. 3c, the system carrier 120 preferably has latching projections 123, which extend towards each other at the side of the switch member 30. Each switch 31, 32 has a plate-shaped part including a break-through for a respective electrical switch element 31a, 32a of the respective switch 31, 32. By way of example, the switch elements 31a, 32a are configured as rocker switches. The plate-shaped parts serve as support portion 31b, respectively 32b. The switches 31, 32, with their portions 31b, 32b, come to bear on the latching projections 123 from the outside with regard to the system carrier 120. Towards the printed circuit board 33 of the switch, preferably resiliently configured clamping portions 31c, 32c configured laterally at the switches 31, 32 and respectively protrude in the direction of the associated latching projection 123, are adjacent to the portions 31b, 32b. They are configured such that, with the support portions 31b, 32b, they surround the latching projections 123, so the switches 31, 32 are supported and the entire switch member 30 is held in position.

The installation procedure is as follows: Initially, the printed circuit board 33 of the switch is inserted from the top, namely in the −y coordinate direction in FIG. 3c, into the system carrier 120. Once the latching projections 123 are located between the clamping portions 31c, 32c and the printed circuit board 33 of the switch, the switches 31, 32 are simply pushed as far towards the latching projections 123, namely in the +x coordinate direction in FIG. 3c, until the clamping portions 31c, 32c have overcome the latching projections 123, and therefore latch therein and the switch member 30 has thus reached the position shown in FIG. 3c.

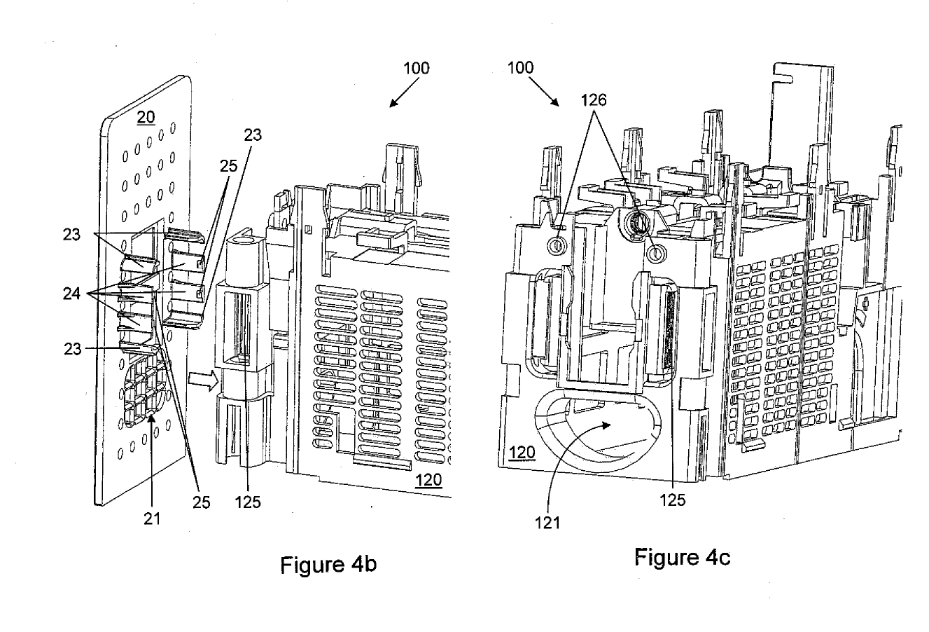

FIG. 4 shows partial views of the door drive 100 of FIG. 1 with regard to mounting the lateral screen 20. In this case, FIG. 4a is a sectional view through the system carrier 120 along a line, which is displaced a little bit in the direction of the lateral screen 20 and parallel to line A-A. The lateral screen 20 has through-openings, respectively switch openings 22 for the switches 31, 32 to pass therethrough, so once installed, the switches can be manipulated from the outside.

In order to have air circulate from the lateral screen 20, respectively the ventilating grille 21 thereof to the parts of the door drive 100, respectively in opposite direction, the system carrier 120 has a through-opening 121, which, in the installed condition, is aligned with a cooling air flow passing through the ventilating grille 21.

At the side facing the system carrier 120, the lateral screen 20 has fastening devices in the shape of projections 23, 24 projecting in the direction of the system carrier 120. By way of example, they include a quadrangle with rounded corners. The projections 23 thus disposed in the corner areas of this quadrangle serve to push the lateral screen 20 onto the system carrier 120 in a guided manner. In cross-section, the thus configured push-on projections 23 are not straight, but angled, respectively as illustrated here and seen in the longitudinal direction of the system carrier 120, they are configured to be concave and arched at the sides facing each other. At corresponding locations, the system carrier 120 has essentially complementary guiding portions 124 configured to be convex. Thus, the lateral screen 20 is already pre-positioned when being pushed-on, respectively when being inserted into the system carrier 120, just the insert depth is not determined yet.

To fix the insert depth of the lateral screen 20, a latching mechanism is provided. The arched shape of the projections 23 interferes with a flexible resiliency of the projections 23. Therefore, they are rather not suited for a latching mechanism. This is why, in addition, the aforementioned projections 24 are provided, which in cross-section are configured to be flat and resilient. At their free ends, by way of example the latching projections 24 have latching noses 25 facing each other. When being inserted into the system carrier 120, the latching noses 25 reach engagement with corresponding latching recesses of the system carrier 120. In the illustrated example, these latching recesses are configured by respective latching groove portions 125 of the system carrier 120. Each latching groove portion 125 has a plurality of latching grooves, which are not identified in detail, that extend parallel with regard to each other and essentially transversely to the insertion direction of the lateral screen 20. In FIG. 4b, the insertion direction is suggested by a block arrow. It is thereby possible, depending on the respective conditions, to be able to vary the insertion depth of the lateral screen 20.

FIG. 4a shows the latching engagement of the latching noses 25 in a respective latching groove, in this case of a visible portion 125. FIG. 4b shows the disposition prior to installing the lateral screen 20 along the block arrow.

Obviously, instead of several latching grooves, respectively one latching recess corresponding to the latching nose 25 may be configured, however linked to the disadvantage of the missing variable insertion depth.

This positioning mechanism allows for an installation, which simply consists of inserting the lateral screen 20 into the system carrier 120 by pushing it on the latter. The portions 23, 24, 124 ensure that the above described switches 31, 32 can pass through the associated through-openings 22 of the switch member 20, and that, as already described above and by way of example, the ventilating grille 21, for the cooling air stream, is aligned with the aeration opening, respectively through-opening 121 of the system carrier 120.

FIG. 4c shows the system carrier 120 in the direction of the frontal face facing the non-illustrated lateral screen 20. Furthermore, as can be seen, the system carrier 120 has two projections 126, which extend in the direction of the lateral screen 20 and serve as an abutment, respectively as a contact surface for the non-illustrated lateral screen 20. This means, the abutment projections 126 determine the maximum insertion depth of the lateral screen 20 with regard to the system carrier 120.

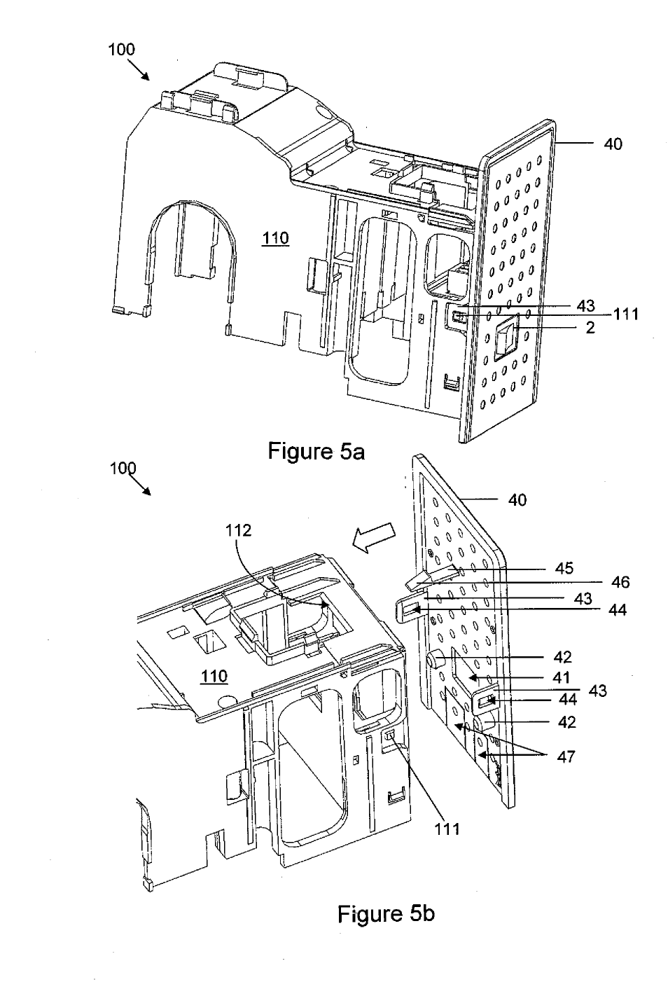

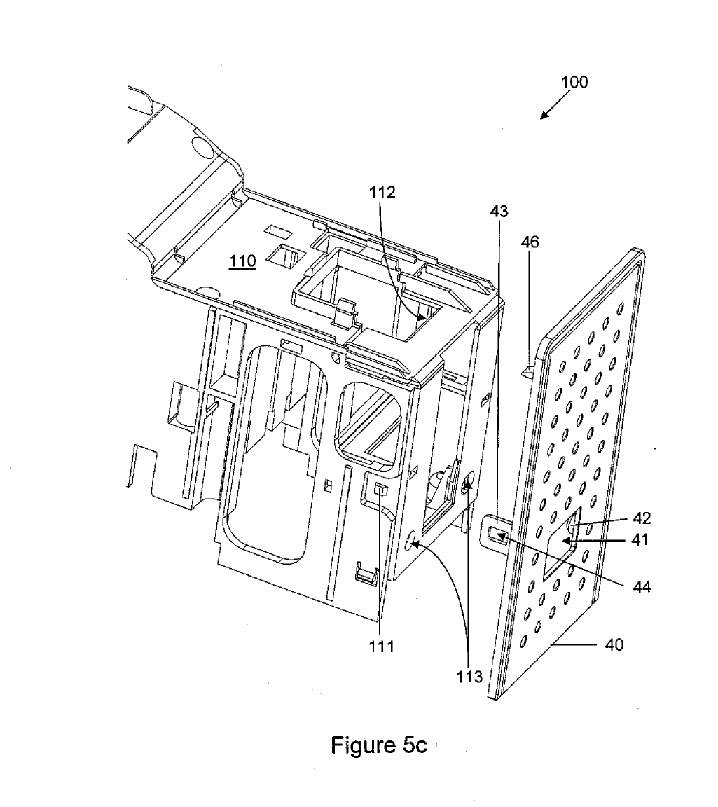

FIG. 5 shows the connecting module 110 of the door drive 100 in different views in conjunction with a lateral screen 40. In this case, the lateral screen 40 closes the frontal face which is opposite to the one in FIG. 3 of the door drive 100 represented by the connecting module 110. An exemplary ON-OFF switch 2 for the door drive 100 passes through the lateral screen 40, similarly to the lateral screen 20. Preferably, the lateral screen 40 is latched to the connecting module 110. By way of example, this is done by two tongues as the fastening projections 43, only one being visible in FIG. 5a. By means of a latching recess 44, each fastening projection 43 latches with an associated latching nose 111 configured at the connecting module 110.

FIG. 5b shows the disposition of FIG. 5a from another perspective and prior to installing the lateral screen 40 onto the connecting module 110 in the direction of the block arrow. In this case, the two fastening projections 43, in the shape of a respective latching tongue, with a respective latching recess 44 located inside, are visible. Furthermore, preferably an additional fastening projection 45 with a latching nose 46 is provided at the free end of the fastening projection 45. In the illustrated example, the latching nose 46 is configured so that the latching projection thereof (not indicated) points upwards in FIG. 5b. In the installed condition, the latching nose 46 engages behind an associated latching surface 112 of the connecting module 110. Thereby, the lateral screen 40 is kept in the installed position by three latching mechanisms 111, 43, 44 and 112, 46. In addition and by way of example, the lateral screen 40 has a through-opening 41 which serves for the above indicated switch 2 to pass therethrough. Furthermore, preferably the lateral screen 40 has insert projections 42, which protrude in the direction of the connecting module 110. They engage, as can be seen in FIG. 5c, in corresponding insert openings 113 of the connecting module 110. The fastening projections 43, 45 are thereby relieved from positioning the lateral screen 40 at the connecting module 110. In addition, a latching nose 46, a latching projection 43 with latching opening 44, as well as the latching nose 46 with associated latching surface 112 can be seen.

Preferably the lateral screen 40 has moreover pre-punched break-away areas 47, for example to possibly pass external power supply lines through the broken-away areas 47 of the lateral screen 40.

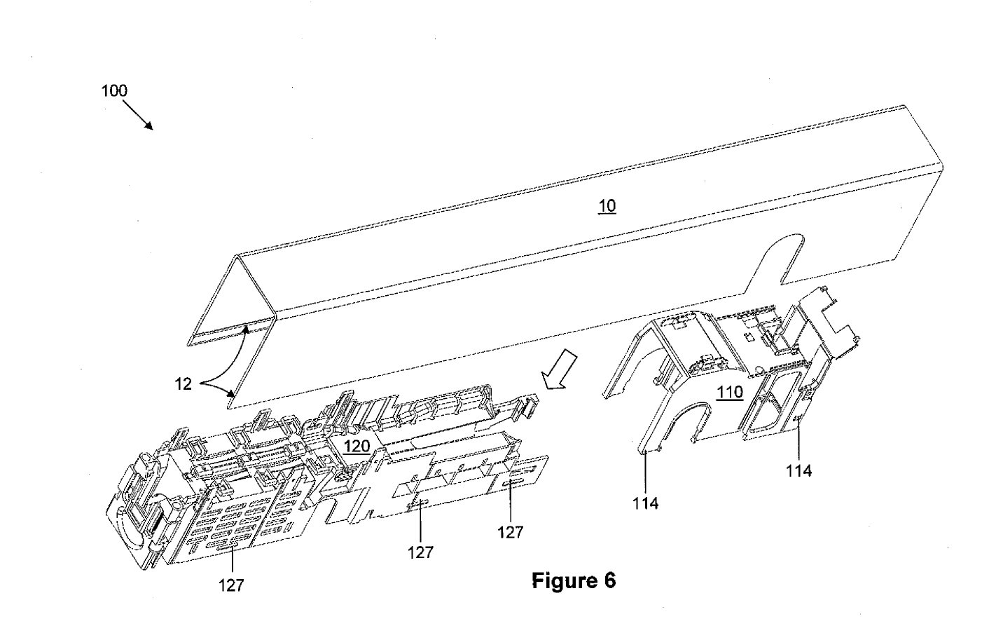

FIG. 6 shows the system carrier 120, the connecting module 110 and the covering hood 10 in an exploded view. In order to fasten the covering hood 10, at surfaces, facing each other, of its non-identified lateral legs, the hood has groove-shaped recesses 12, which preferably extend over the entire length of the covering hood. When placing the hood along the block arrow, the recesses 12 reach a latching engagement with corresponding projections 127, 114, in this case only visible at one side, of the system carrier 120, respectively of the connecting module 110, what represents a very simple mounting of the covering hood 10. Instead of several latching projections 127, or 114, respectively one latching projection 127, or 114 may be provided, which is configured to be continuous.

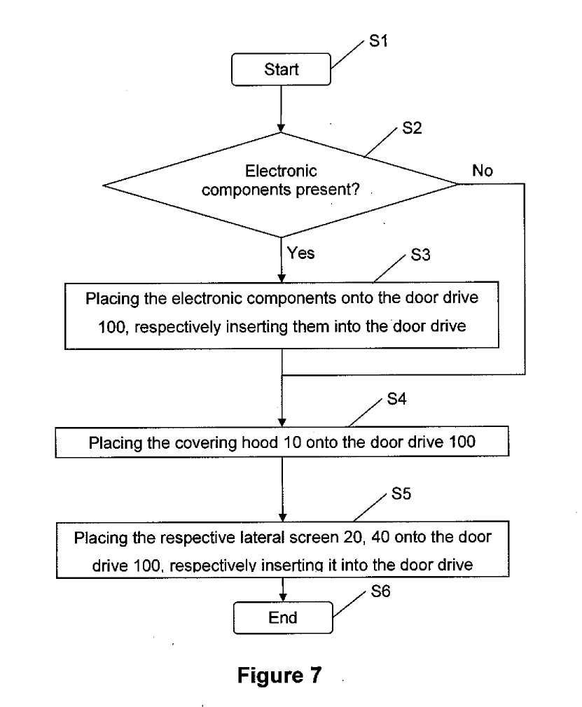

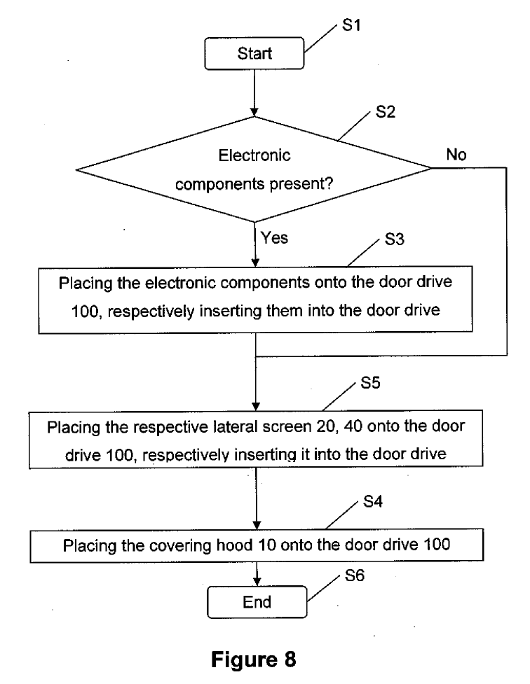

FIG. 7 shows an installation method for the encasing, comprising the lateral screen(s) 20, 40 and of the covering hood 10. After starting with step S1, if electronic components (for example the switch member 30) in conjunction with one of the lateral screens 20, 40 are to be mounted (branch YES following step S2), in a subsequent step S3 the respective component is placed onto the respective fastening device(s) 122, 123 of the door drive 100 or they are inserted into the device(s). Thereupon, or if no more electronic components are to be installed (branch NO following step S2), in a following step S4, the one or more lateral screens 20, 40 are placed onto the associated fastening device(s) 124, 125, 127 of the door drive 100 or are inserted into the device(s). Finally, in a step S5, the covering hood 10 is placed onto the door drive 100, or better onto the fastening devices 114, 127. Should one of the lateral screens 20, 40 be spaced apart from the covering hood 10, in an additional step, not-illustrated in this case, it may be provided to move these lateral screens 20, 40 further towards the covering hood 10. Thereupon the installation is finished in a step S6.

FIG. 8 shows an installation method which, compared to FIG. 7, is modified. Unlike in the previous embodiment, the steps S4 and S5 are interchanged. This means the covering hood 10 is mounted prior to mounting the lateral screens 20, 40. This is advantageous in that the lateral screens 20, 40 can be correctly installed with regard to their insert depth when putting them in place, because the covering hood 10 is already installed.

The invention in its configuration is not limited to the above described embodiments.

The fastening devices 23 to 25; 42 to 46 of the lateral screens 20, 40 may be interchanged or they may be combined with each other. In this case, the system carrier 120 and the connecting module 110 are correspondingly configured.

Instead of the system carrier 120 and of the connecting module 110, other parts as well, such as the gear housing 103, may be configured to stationarily receive one of the respective lateral screens 20, 40.

The latching recesses 12 and the corresponding latching projections 127, 114 may be interchanged. Furthermore, these latching elements may be configured at other parts, such as at the gear housing 103.

The door drive 100 may be replaced by any type of door drive or door closer, as long as it includes fastening devices for lateral screens.

The above described installation method may be modified in so far that in case of two lateral screens 20, 40, the steps S3 and S4 are processed in an interlaced manner. This means, the electronic components for a lateral screen 20, 40 are installed (S3). Thereupon, the associated lateral screen 20, 40 is installed (S4). Thereupon, the electronic components for the other lateral screen 40, 20 are installed (S3). Finally, the second lateral screen 40, 20 is installed (S4).

The through-openings of the above described ventilating grille 21 may be likewise used to make switches or display elements accessible, respectively visible from the outside.

As a result, the invention provides a simple and installation-friendly covering, respectively a facing for a door operator.

1.-7. (canceled)

8. A door operator stationarily affixed to a carrying body configured to at least one of open and close a connected door leaf, comprising:
at least one lateral screen;
a covering hood, that is open at the at least one lateral screen;
first fastening devices configured to stationarily receive the at least one lateral screen at an associated frontal side of the door drive that are configured to determine an insert depth of the at least one lateral screen;
second fastening devices configured to stationarily receive the covering hood;
projections of the lateral screen that insert the lateral screen into the door operator and push the screen onto the door operator in a guided manner; and
guiding portions arranged to be substantially complementary to the projections,
whereby the lateral screen, when being inserted into the door operator, is preliminary fixed with regard to the door operator, except for an insert depth of the lateral screen.

9. The door operator according to claim 8, wherein the first fastening devices and the at least one lateral screen are arranged at each frontal side.

10. The door operator according to claim 8, wherein the first fastening device is configured to stationarily receive an associated electronic component at a respective frontal side of the door drive.

11. The door operator according to claim 8, wherein the at least one lateral screen has at least one through-opening for an element of an associated electric component to pass therethrough.

12. The door operator according to claim 8, wherein
the at least one lateral screen has at least one through-opening, which, in its installed condition, extends along a longitudinal extension of the door drive, and
is aligned with a cooling air stream of the door drive in an area of the at least one lateral screen.

13. An installation method for a covering hood of a door operator, comprising:
pushing at least one lateral screen onto associated first fastening devices of the door operator; and
placing a covering hood onto associated second fastening devices of the door operator.

14. the installation method according to claim 13, wherein
the door operator is configured to stationarily receive an associated electronic component at a respective frontal side of the door drive, and the installation method further comprises
fastening the electronic component at an associated frontal side of the door operator, before the pushing the at least one lateral screen onto the same frontal side of the door operator.

15. The door operator according to claim 9, wherein the first fastening device is configured to stationarily receive an associated electronic component at a respective frontal side of the door drive.

16. The door operator according to claim 15, wherein the at least one lateral screen has at least one through-opening for an element of an associated electric component to pass therethrough.

17. The door operator according to claim 16, wherein
the at least one lateral screen has at least one through-opening, which, in the installed condition, extends along a longitudinal extension of the door drive, and
the at least one lateral screen is aligned with a cooling air stream of the door drive in an area of the lateral screen.
